(19) United States
(12) Patent Application Publication
(10) Pub. No.: US 2008/0259358 A1
(43) Pub. Date: Oct. 23, 2008

(54) Display Material Provision

(76) Inventor: Richard Michael Lucas, Slough (GB)

Correspondence Address: GREENBERG & LIEBERMAN, LLC, 2141 WISCONSIN AVE, N.W., SUITE C-2, WASHINGTON, DC, 20007, US

(21) Appl. No.: 11/575,371

(22) PCT Filed: Sep. 15, 2005
(86) PCT No.: PCT/GB2005/003541

§ 371 Date: Apr. 7, 2008

(30) Foreign Application Priority Data
Sep. 15, 2004 (GB) 0420506.8

(51) Int. Cl. G06F 3/12

(52) U.S. Cl. 358/1.1

(57) ABSTRACT

The present invention relates to a method and apparatus for provision to customers of display material without intervention by an attendant. It is known to dispense material to attendees and prospective customers at meetings, exhibitions, conferences and commodity or product shows of all kinds, in an anonymous fashion from unattended literature racks and the like. The material to be dispensed usually comprises brochures, pamphlets and other printed material describing the item of interest which attracted the potential customer or attendee. It is not always possible to have a human attendant present, and even if one or more attendants are present, it may not be possible to meet the instant needs of a large crowd. The present invention seeks to provide means whereby the needs of every individual can be met, whether or not a human attendant is present, whilst allowing the attendee the choice of remaining anonymous or not. In accordance with the present invention, there is provided a point of display document dispenser comprising: coupling means for accepting coupling of a portable electronic memory device to said point of display dispenser; detection means for detecting when a portable electronic memory device is coupled with said coupling means and providing output indicative thereof; and data transfer means, operative, on the condition that said detecting means has provided said output, to transfer an electronic copy of a document in an associated memory means to the portable memory device or to receive an identification address.

### FIELD OF INVENTION

The present invention relates to a method and apparatus for provision to customers of display material without intervention by an attendant.

### BACKGROUND TO THE INVENTION

It is known to dispense material to attendees and prospective customers at meetings, exhibitions, conferences and commodity or product shows of all kinds, in an anonymous fashion from unattended literature racks and the like.

The material to be dispensed usually comprises brochures, pamphlets and other printed material describing the item of interest which attracted the potential customer or attendee. It is not always possible to have a human attendant present, and even if one or more attendants are present, it may not be possible to meet the instant needs of a large crowd. The present invention seeks to provide means whereby the needs of every individual can be met, whether or not a human attendant is present, whilst allowing the attendee the choice of remaining anonymous or not.

One answer to the question of the absence of human attendants is to provide a “point of display” dispenser where pamphlets, brochures, or other printed material is stacked next to the item which attracted interest. The point of display dispensers typically will beat an encouraging advert or message urging the attendee or potential customer to “please take one”. Such point of display dispensers will be familiar beside vehicles in vehicle shows and beside items of equipment or at unattended stands in trade fairs or exhibitions.

One problem with point of display dispensers is that insufficient brochures or pamphlets can be provided, allowing the point of display dispenser to “run out” of printed matter and thus lose or disappoint potential customers. The present invention seeks to provide means whereby a point of display dispenser can never run out.

Another problem that arises with point of display dispensers is the problem of transporting the weight that the printed matter can represent. Often, a sufficient number of items of printed matter to satisfy the possible demands of potential customers is inconveniently large and heavy. To take less would mean that potential customers could be missed. However, much of the printed material might not be collected by potential customers and the residue will requite either to be discarded (a waste of money) or (inconveniently) to be transported back from the conference, show or exhibition.

WO9840840 provides an identity badge system comprising a portable identification memory device, an identification writer for writing a user's identification in the memory device, a label printer connected to the identification writer for printing a label, a label with a part of the users identification in large distance-legible letters, the label being fixed on the memory device, a memory device holder with an attachment for attaching to a users clothing, and associated paraphernalia. Instead of the usual paper or cardboard tag that are dispensed by the organizers of an exhibition or similar, each attendee wears a plastic holder on a shirt or a jacket which is operable to retain a portable badge that can be written to and read by a computer type device. A preferred manifestation of this is a 3.5″ floppy disk as used for personal computers. The badge would contain a paper label stuck on it to allow people to visually read the attendee's name, company, etc, along with any other identification needed for access to the event's activities (tutorials, show, conference, etc). The stated advantages are that it allows the event coordinator to create the badge directly from the coordinator's computer since it can write directly to the floppy any information that has been obtained via mail, telephone, etc. regarding the attendee. The floppy and its paper label are prepared before the conference if the attendee has pre-registered, or are prepared at the conference site if he appears on that morning or if a change is needed. In addition to his identity, the badge would have software written on it to control any exchange of data from the badge to others parties.

A disadvantage of this system is that during use of the electronic badge, the user becomes otherwise unidentifiable—since his lapel badge is removed and inserted into the device. Furthermore problems may arise through the misuse of the data held on the card. In the event of loss of the card, there are no systems in place to protect the user from “identity theft”, to restore lost data or to prevent misuse of the card. Some exhibition organizers will not re-issue a badge; others will levy a fee for such a service. It may be that the badge can assume a value far greater than its nominal value. It is believed that increasing the apparent value is not wise and can lead to consequential problems such as identity theft.

US2003110371 provides a method and an apparatus for transferring user specific information from one computer to another. One version uses USB flash memory devices which enables a user's settings with respect to a computer screen (layout of outlook bats etc.) to be uniform, irrespective of choice of computer for a peripatetic computer user. This teaching provides a user specific and user identifiable system and provides a system which relates to the storage of preferences. Thus this teaching solves a problem associated with the fact that preferences are stored on each individual PC and tend not to be centralized in SOHO environments. In a large corporation, however, user preferences are centralized and when you log in to one PC it retrieves all the user preferences and application data based on your login from a central server.

Some versions of the Linux Oscan operate in a similar fashion as the OS can be run from a CD ROM in any PC with a floppy disc, USB stick or other memory device containing preferences. That is to say that once a CDROM has been inserted into a computer CD drive and it is booted up, then preferences can be determined.

Nevertheless, given the disadvantages arising from the above systems and the fact that data concerning the attendee present is freely transferred, such systems are simply not acceptable for many business users. Equally, data storage issues can be a problem, as can be the possibility of transferring viruses and phishing of the stick for data, a need exists for a system that provides a safe and useful alternative.

### OBJECT OF THE INVENTION

The present invention seeks to provide a solution to the problems addressed above.

The present invention seeks to provide means whereby the amount of physical material which is required to be provided and/or transported to an exhibition and similar type of gathering is kept to a minimum.

### STATEMENT OF INVENTION

In accordance with a first aspect of the invention, there is provided a point of display document dispenser comprising: coupling means for accepting coupling of a portable electronic memory device to said point of display dispenser; detection means for automatically detecting when a portable electronic memory device is coupled with said coupling means and providing output indicative thereof; and data transfer means, wherein the data transfer means is operative, on the condition that said detecting means has provided said output, to transfer data, whereby die identity or identifying details of a person inserting the memory device need not be disclosed. This is of advantage to certain groups of people because it retains the anonymity of paper-based literature distribution and enables such persons to seek further data when they requite, rather than being approached by representatives of at each and all of the stands at an exhibition that they might have collected information from. By advocating the use of an anonymous memory device, together with a trusted third party, the activity commonly known as “phishing”, where data theft, which may result in identity theft, is effectively eliminated.

The transfer of data can comprise automatic transfer of an electronic copy of a document from the display dispenser to the portable electronic memory device. This provides instantaneous downloads of exhibition brochures and other materials.

3. The transfer of data can comprise a subsequent transmission of data to the person, by electronic mails or another means. The identification of the memory device can be correlated, at a later time, by a trusted third party, for example the event organiser: the disclosure of the delegate profile would not necessarily be given to the exhibitor.

The trusted third party can use data obtained for many different purposes, for example, he may sell this data—provided appropriate levels of anonymity are maintained, in accordance with data protection legislation, for example the Data Protection Act in the United Kingdom.

4. The electronic copy of the document could be an electronic encoding of a brochure, pamphlet or other document, for example, an e-presentation, including videos, slides and animations. The document dispenser could provide an advertising surface to show an indication of the nature of a document which can be dispensed if a portable memory device is coupled to the document dispenser.

The document dispenser could also provide dispensing means for holding one or more printed copies of a document to be dispensed to a user.

The memory device can comprise flash memory, Erasable Programmable Read-only Memory, battery maintained Random Access Memory, or magnetic disk drive.

In accordance with another aspect to the invention, there is provided a method of providing an encoded document from a point of display document dispenser comprising the steps of:

storing in a memory a copy of a document to be dispensed to a user;
accepting coupling of a portable electronic memory device;
detecting when a portable electronic device is coupled;
and enabling transfer of data.

In accordance with another aspect of the invention, there is provided an exhibition display system including such a point of display apparatus.

### BRIEF DESCRIPTION OF THE FIGURES

For a better understanding of the present invention, reference will now be made, by way of example only, to the Figures as shown in the accompanying drawing sheets, wherein:—

FIG. 1A shows a projected view of a first embodiment of the invention;

FIG. 1B shows a projected view of a second embodiment of the invention;

FIG. 1C shows a projected rear view either of FIG. 1A or FIG. 1B showing how connection can be made to an external processor;

FIG. 2A is a projected front view of another embodiment of the invention where a dedicated processor is provided;

FIG. 2B is a version of FIG. 2A where one memory slot and more than one button are provided;

FIG. 2C is a version of FIG. 2A where more than one slot is provided;

FIG. 2D is a projected front view of a version of FIG. 1A where two possible lots of down-loadable data are presented;

FIG. 3 is another version of the invention where copies of printed matter are also provided;

FIG. 4 is a flow chart showing the basic data download activity;

FIG. 5 is a flow chart showing how more than one set of data can be selectably downloaded;

FIG. 6 is a projected rear view of a version of the invention showing one way in which a selectably operable upload button can be provided;

FIG. 7 is a flow chart illustrating one way in which data can be uploaded to be dispensed; and,

FIG. 8 is an overview of an exhibition scenario.

### DETAILED DESCRIPTION OF THE PREFERRED EMBODIMENTS

There will now be described, by way of example only, the best mode contemplated by the inventor for carrying out the present invention. In the following description, numerous specific details are set out in order to provide a complete understanding to the present invention. It will be apparent to those skilled in the art, that the present invention may be put into practice with variations of the specific

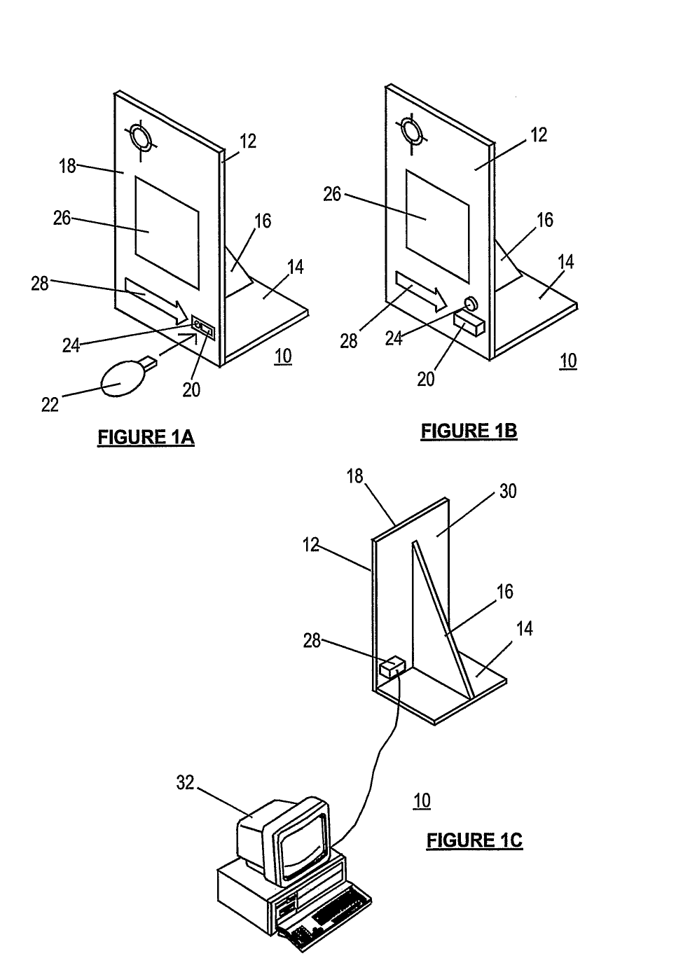

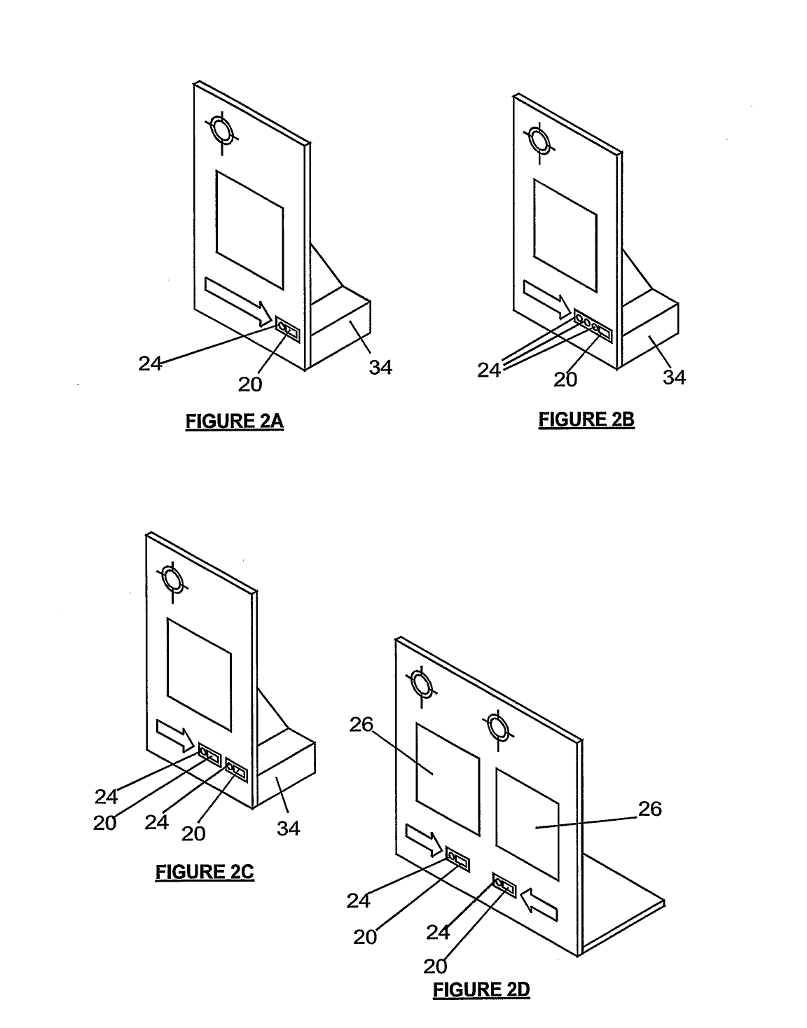

With reference to FIG. 1, there is shown a perspective Attention is first drawn to FIGS. 1A, 1B and 1C, showing first and second versions of the invention, and one way in which they can be connected to an integral part free standing processor.

A point of display dispenser 10 comprises a display member 12 for general viewing by the public, a base 14 and a support strut 16, co-operative to allow the assembly and the dismantling of the point of display dispenser 12. This illustrates just one, non-exclusive way in which a point of display can be assembled according to the invention, and many other ways are possible.

The display member 12 comprises a front surface 18 whereon is provided a socket 20 which allows a portable electronic memory device 22 to be plugged in. Optionally, there is also provided a button 24 which can be pushed when the portable electronic memory device 22 is plugged in the event that the delegate wishes to be contacted by the exhibitor operating the particular display member. The front surface 18 also comprises advertising material 26 indicative of data which can be downloaded from the socket 20 and an indicator 28 showing where the socket 20 is located. A single or multiple indicator lights or other display/aural indicator may be provided whereby to indicate: i) correct functioning, ii) memory full or iii) transfer complete or iv) some other information.

In FIG. 1A the socket is shown as a USB (Universal Serial Bus) socket for accepting insertion of a USB portable memory device 22. As will become clear, the portable electronic memory device 22 can be any such device 22 capable primarily of downloading data from the point of display dispenser 10, and preferably also capable of uploading data to the point of display dispenser 10. One, non-exclusive example of such a device is the “Cruzer Mini” SanDisk™ device offered as catalog number A07BR in the Maplin™ Winter 2005/5 catalogue page 48.

In FIG. 1B the socket 20 is shown basically as any other type of socket 20 capable of coupling a portable electronic memory device 22 to the point of display dispenser 10. Many such portable electronic memory devices are becoming popular and are serving as an alternative to floppy discs, CD ROMS, Zip Discs, and the like. For preference the portable electronic memory device 22 comprises Flash memory, which stores data without use of further energy. However, the invention also encompasses use of any other kind of non-volatile memory technology, such as EPROM (Electronically Programmable Read Only memory) and battery maintained RAM (Random Access Memory), to name but two possibilities. Socket 20 can be exchanged if worn out due to excessive use. Ideally more than one socket is provided to cater for frequently visited display units.

FIG. 1C shows how a connector 28 is provided on the reverse side 30 of the display member 12 or either of the versions of the invention shown in FIG. 1A or 1B to couple the socket 20 and the button 24, which is connected to a PC 32, whereby to update a display and/or to provide additional functionality.

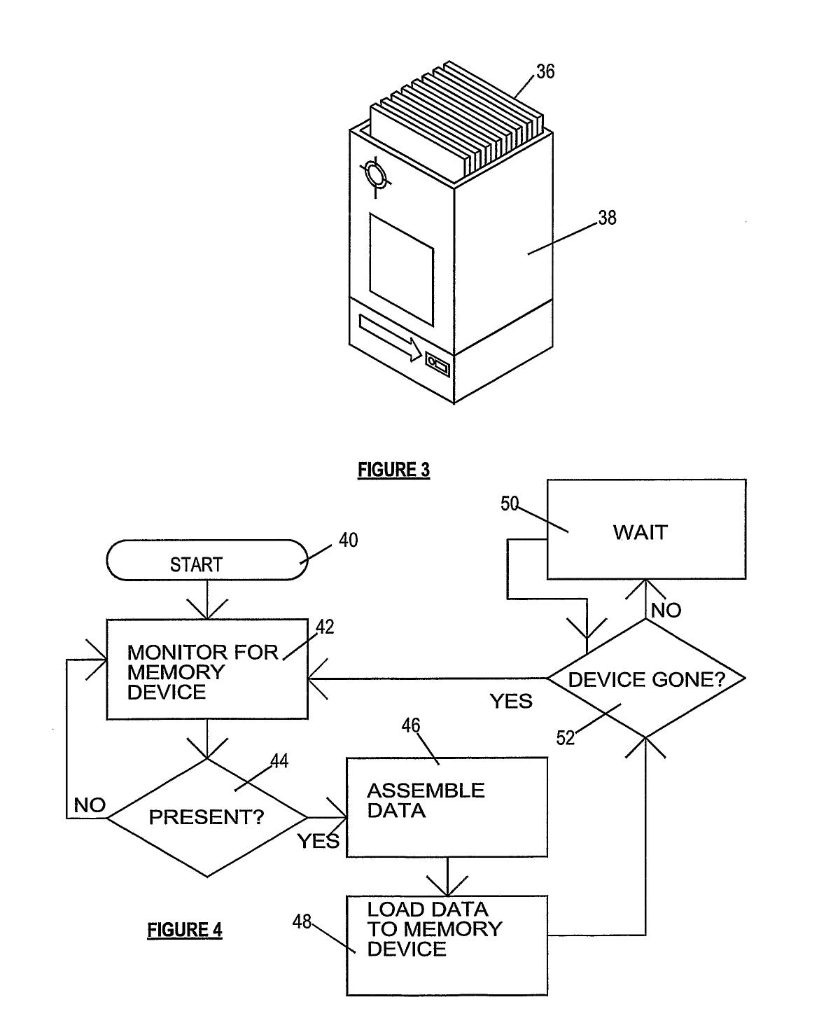

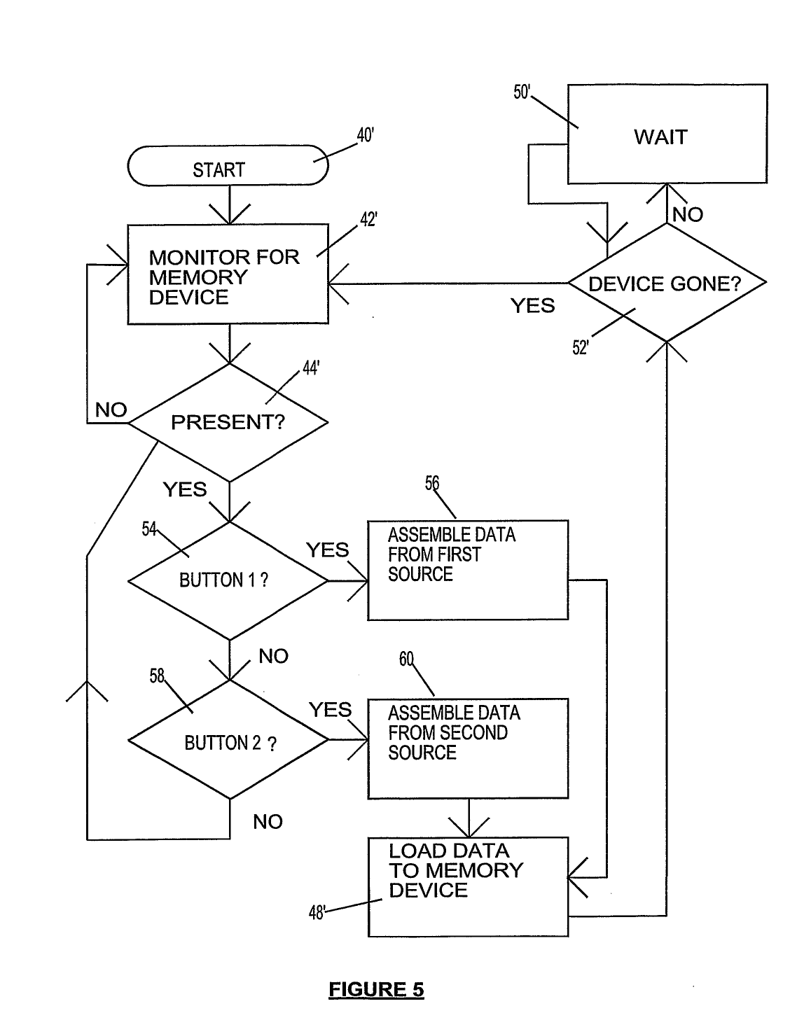

Attention is next drawn to FIG. 2A, which is a projected front view of a another embodiment of the invention where a dedicated processor is provided, to FIG. 2B, which is a version of FIG. 2A where one memory socket 20 and more than one button 24 are provided, and to FIG. 2C, which is a version of FIG. 2A where more than one socket 20 is provided.

In FIG. 2A, everything is as in FIGS. 1A to 1C, with tie exception that a dedicated processor 34 is provided, incorporating tie connector 28 and the stand alone processor 32 of FIG. 1C. FIG. 2A shows a single socket 20 and button 24. FIG. 2B shows a single socket 20 and a plurality of buttons 24, which can be used to select different items to be downloaded to the portable memory device 22, FIG. 2c shows a plurality of sockets 20, which can be used to download different data items, or can be used to service more than one portable electronic memory device 22 at once, or both.

Attention is next drawn to FIG. 2D, showing a projected front view of a version of FIG. 1A where two possible lots of down-loadable data are presented. There are two sockets 20 and two optional buttons 24, and two lots of advertising material 26.

Attention is next drawn to FIG. 3, showing another version of the invention where copies of printed matter 36 are also provided in a dispensing container 38, offering the user the option of electronic or printed data.

The different variants of the invention, as shown in FIGS. 1, 2 and 3, can be applied, within the scope of the invention, individually or collectively in any combination to provide yet further variants.

Attention is next drawn to FIG. 4, showing a flow chart illustrating the basic data download activity. From entry 40 a first operation 42 monitors the socket 20 until a first test 44 detects that a portable electronic memory device 22 has been inserted. A second operation 46 the assembles the data to be downloaded from the memory of the stand alone processor 32 or of the dedicated processor 34 and a third operation 48 loads the data to the portable electronic memory device 22 via the socket 20. The stand alone processor 32 or the dedicated processor 34 waits in a fourth operation 50 until a second test 52 detects that the portable electronic memory device 22 has been removed from the socket 20, when control is returned to the first operation 42, where insertion of another portable electronic memory device 22 is looked for, ready to start again.

Attention is next drawn to FIG. 5, showing a flow chart illustrating how more than one set of data can be selectably downloaded. Items 40′, 42′, 44′, 48′, 50′ and 52′ of FIG. 5 correspond respectively to items 40, 42, 44, 48, 50 and 52 of FIG. 4 and enjoy the same description and numbering. FIG. 5 differs from FIG. 4 in that the one or more buttons 24 are checked. In this example there are two buttons, but there could be just one button 24, or three or more. From the first test 44′, a third test 54 looks to see if a first button 24 has been pushed. If it has, a fifth operation 56 assembles a first set of data from a first location in the memory of the stand alone processor 32 of the dedicated processor 34 and passes control to the third operation 48′ which continues as described for FIG. 4.

If the third test does not detect that a first button 24 has been pushed, a fourth test 58 looks to see if a second button 24 has been pushed. If it has, a sixth operation 60 assembles a second set of data from a second location in the memory of the stand alone processor 32 of the dedicated processor 34 and passes control to the third operation 48′ which continues as described for FIG. 4. If the fourth test 58 does not detect that a second button 24 has been pushed, control is passed either to the first test 44′ (as shown), or to the second test 52′ (not shown) which continue as described with reference to FIG. 4.

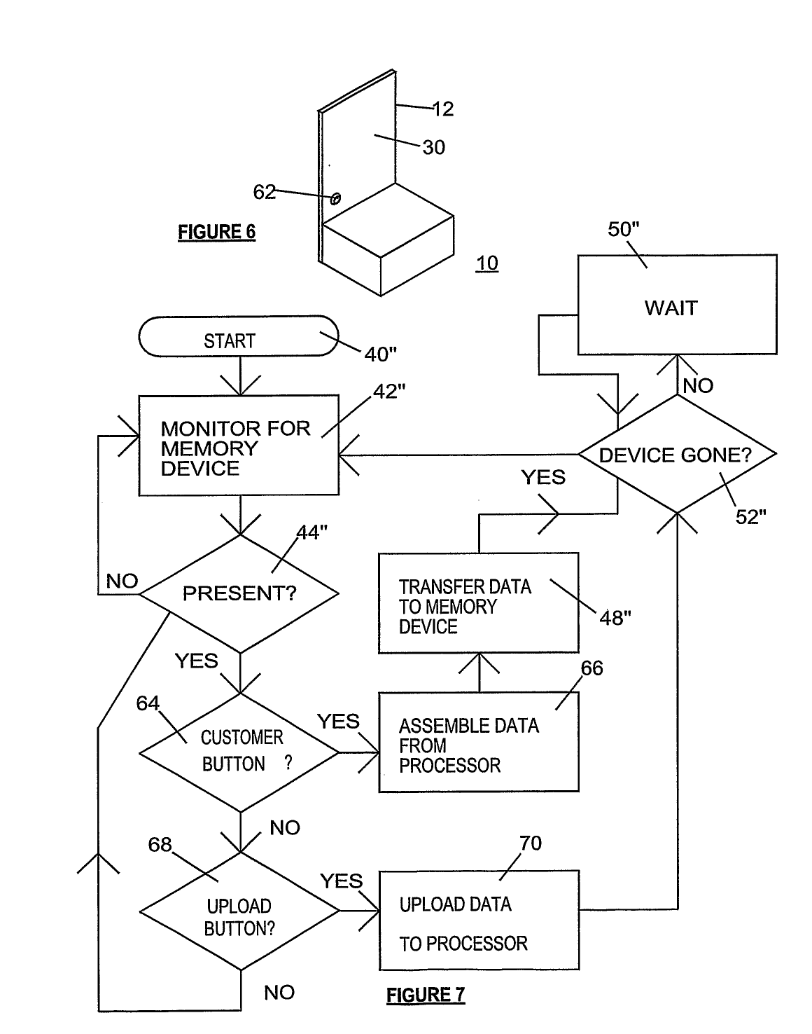

Attention is next drawn to FIG. 6, showing a projected rear view of an exemplary version of the invention showing one way in which a selectably operable upload button can be provided. A point of display dispenser 10 comprises an upload button 62 in a generally customer inaccessible position (here shown on the reverse side 30 of the display member) which, when operated, indicates to the processor (here shown as a dedicated processor 34′) that data is to be uploaded. The upload button may equally well be implemented as a key switch operated generally in the manner of a lock to be operated by a separate key, or as a thumb wheel, or as binary or rotary switches which must be set to a predetermined code to cause “activation” of the upload button.

Referring now to FIG. 7, there is shown a flow chart illustrating one way in which data can be uploaded to be dispensed. In FIG. 7, items 40″, 42″, 44″ 48″, 50″ and 52″ correspond to items 40′, 42′, 44′, 48′ 50′ and 52′ of FIG. 5 and to items 40, 42, 44, 48, 50 and 52 of FIG. 5 and enjoy the same functions and description for each. In FIG. 7, from the first test 44″, a fifth test 64 checks to see if a customer button 24 has been pressed. If it has, a seventh operation 66 assembles the data from the memory in the dedicated processor 34 or the stand alone processor 32 and transfers control to the third operation 48″ which continues as described for FIGS. 4 and 5.

If the fifth test does not detect that a customer button 24 is pushed, a sixth test looks to see if the upload button 62 has been operated. If it has, an eighth operation 70 uploads data, from the portable memory device 22 in the socket 20, and deposits it in the memory of the memory in the dedicated processor 34 or the stand alone processor 32. The data may be uploaded to a separate location as separate data for download, or may overwrite and replace the existing data, dependently upon markers on the data or the setting of the upload button, which can be provided with two or more settings.

By logging the storage device, serial number, model and manufacturer a trusted 3rd party can reconcile the identity of a device with the exhibitor and the delegate—if registered. If a delegate has registered his memory device with the exhibition organizer, then this means that in the event of loss of the storage device, information can be provided by means of can contact the organisers and downloading the required information through a website or other channel. This, of course, is a good reason why delegates should register their memory devices with the trusted third party.

In use, the system consists of a centrally maintained database of user details and documents (a document management system and a user management system), we have a third database on the ‘logging server’ which connects users to their documents by processing the ‘log file’ of all user downloads from each unit so that in the event of a stick being lost, locked, not enough space, even unreadable data section (if we can still read the serial number of the stick) the user does not lose their documents.

In addition we have a document browser which allows users to browse their documents by exhibition, exhibitor, date, product category, alphabetically, file by file and using free text search. This document browser ‘syncs’ with the central database so that a user can keep a local copy of their documents. In larger organisations, such as a scientific body like CEFAS who have 500 scientists we allow them to register as a ‘library’ or ‘invisible university’ to be able to browse each others documents (just as they would pass a paper document from office to office/department to department). This has the advantage that it can be implemented as a peer to peer network and will not overload a central document server. In addition, delegates can publish their own documents to their own “invisible university” (an association of members who share information amongst themselves, for greater good).

And finally, we can keep a record of units visited on each stick so that the logging database can check and verify these downloads against it's central register, in addition, even if a unit is lost the user will still get the data the next time they insert their stick in another dispenser unit or sync with their document browser.

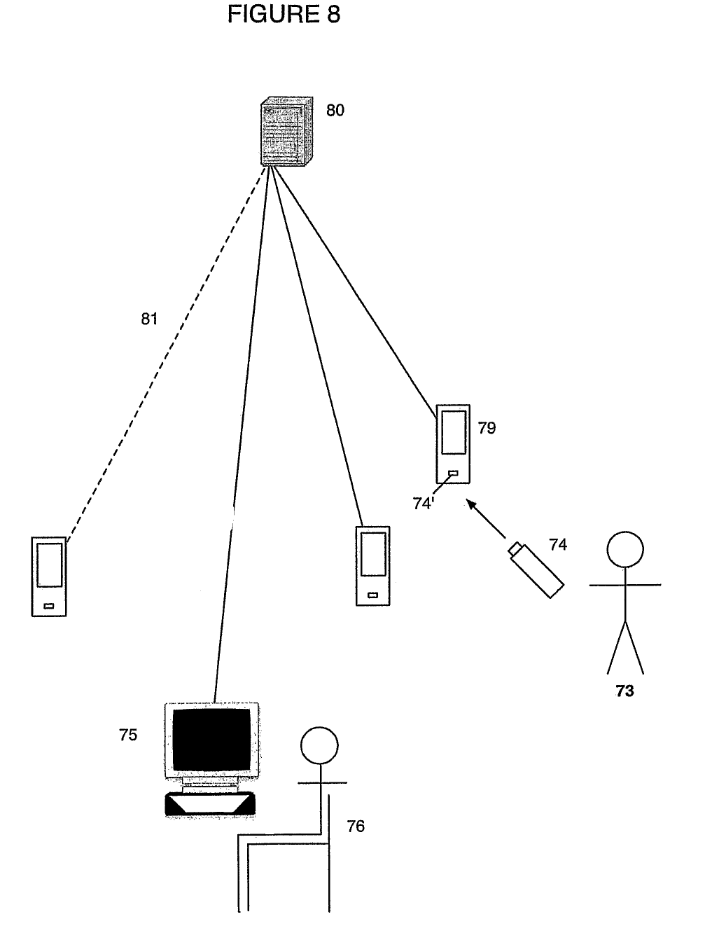

FIG. 8 shows how a document dispenser in accordance with a first aspect of the invention can be incorporated in a system 72, in accordance with a second aspect of the invention. In the system 72, a delegate or attendee 73 will have a memory device 74. This memory device may be the property of the attendee, be supplied by the conference or exhibition organizers/exhibitor sponsor and are conveniently registered or be the property of the delegate. An assistant of the exhibition organizer will therefore log in information, conveniently by inserting the memory device in a port 74′ associated with a terminal 75. This data will be stored in a system memory or content server 77. This may comprise a removable storage element associated with each document display device, which can then be associated with a server associated with the organizer's system, whereby the organizers or another trusted third party can generate data concerning the conference, which may have a value. A wireless connection flow power radio, infra-red) 81 is also shown. Data transfer may be made in realtime or data may be collected and then transferred at the end of a day/end of the exhibition.

Whether or not registered, the delegate will approach the different stands of the exhibition. Where a stand has a display device 79 in accordance with the invention, then he will insert his memory card into a port associated with the display device, as has been described above. The delegate may use his memory device such that his e-mail address is provided to the display device, with an instruction—implicit or specific, dependent upon the pressing of buttons or controlling a touch screen or similar, that information will be sent to his e-mail address or be downloaded to his memory device. The display device may be powered by an internal battery supply (not shown) or have a mains power supply connection (also not shown). Alternatively the communications link 80 may also comprise a power supply. In the embodiment shown the display device does not have an internal memory and data is transferred from the server 77. This means that the display device is not as “intelligent” or as flexible as a desktop PC or laptop, but can be made in a cost effective fashion. Alternatively there may be a local memory facility where further local storage devices and/or memory sticks may be utilised such that the display device is still cost effective and a stand alone device. The display device can be used for different exhibitions, with the memory stick being interchanged, as appropriate. These dispensers can be collected by the trusted third party to enable data collection and compilation of data regarding delegate traffic and document delivery.

Registration is not essential and this feature will be appreciated by those delegates who prefer to be anonymous. The conference organizer will respect the intention of any delegate who wishes to remain anonymous, although there may be benefits, promotions or other incentives to induce delegates to share their identity with the organizers and or/the exhibitors. In order to maintain a “trusted third party status” the wishes of any individual or party must be respected. Notwithstanding the above, in the event that an organiser has delegate information, it will be for the organizer to provide useful data which does not compromise the wishes of delegates who have consented to use being made of their identity being disclosed in whole or in part. This information may be made commercially valuable. Along with the registration of the delegate, an identity code is associated with his memory device. In use, the identity code could be made known to each exhibitor by default or upon positive instruction, by way of pressing a button or otherwise at the display device of an exhibitor.

Typically, in the case of USB devices, there will be a unique serial number associated therewith, at the time of manufacture. There are, however some devices which do not have such serial numbers. This serial number is generated by code relating to the manufacturer, the type and model of the device and a serial number of the device.

Thus the present invention can provide a system where business documents can be anonymously transferred from exhibitors at exhibitions and conferences to delegates either in realtime or after the event and, optionally, delegates can request contact from the exhibitor through a reconciliation service provided by a nominated and trusted third party (if the delegate device is registered and the exhibitor device is manually reconciled or the exhibitor device is networked with the trusted third party service).

It will be appreciated that exhibitors will not wish to receive ‘junk leads’ for every delegate who collects a document from their stand, in addition delegates will not wish to be contacted by every stand from which they collect a document. At the same time delegates wish to collect literature about an exhibiting company and the same company wishes to give it's literature to delegates. Out solution is to provide a simple method of literature provision using a hardware device which copies the business documents to the delegate's device and provide the reconciliation of a delegate's identity with exhibitor's dispensed documents through a trusted third party.

This system preserves the anonymity of paper based literature and brochure distribution whilst at the same time providing greater convenience to delegates and reduced cost of literature production and distribution to exhibitors.

This system overcomes the security concerns of earlier systems by not storing any user details on the delegate storage device, this renders the system invulnerable to ‘device phishing’ the practice of unauthorised copying of data from inserted memory device (into any other device) as the data stored on the storage device merely consists of the documents the user has collected and not their personal identity not any ‘encoded’ personal identity details. In addition should the delegate device be lost then no personal data has been lost with it.

The system seeks to replace the ‘delegate bag’ with a uniquely identifiable portable storage device which is provided to/or purchased by/carried and used by the delegate and an electronic literature rack which is purchased/rented and provisioned by the exhibitor or conference organizer.

An aspect of the ‘invention’ is a simple electronic device which allows for business documents to be transferred from the exhibitor to the delegate without requiting a laptop or desktop computer to be present. This can be achieved by adapting electronics created for the duplication of digital camera photographs from the camera storage to another USB mass storage device. Suitable electronics are available from a number of electronics manufacturers (such as Infinite Data Storage Ltds ODM service) to enable economic volume production.

This device will reduce the capital and running cost of a conventional paper based or laptop or desktop computer based ‘document dispenser’ by a considerable margin (>50%) enabling this technology to be used more widely. The unit requires 10% or less of the power required by a computer based solution. Because of this saving the device will further reduce the cost of literature production and provision for exhibitions and the impact that this has on the environment because the collection devices and dispensers ate re-useable, the printing and transport cost of literature is reduced for the exhibitors and the return transport cost of literature is also reduced for delegates.

In addition the ‘invention’ stores the unique serial number of coupled delegate devices so that this information can later be reconciled through a trusted third party. Registration and subsequent reconciliation of delegates or exhibitors is entirely voluntary and the system does not require this in order to function. The logging of device serial numbers enables a count of the number of inserted devices and successful transactions (copy of documents to the device) in addition to allowing for the optional reconciliation service. Should a delegate storage device be lost, destroyed or otherwise rendered inoperable then the list of unique serial numbers recorded on the exhibitor unit can be used to rebuild the delegates list of business documents on an internet webserver. However the delegate must have registered their stick, prior to losing it, in order to take advantage of the service.

Unlike other systems out system does not require a specifically formatted device and can work with compatible non-storage devices if the optional reconciliation service is used in association with a trusted third patty.

The system does not assume that it will be used in isolation from other uses of the storage device which the delegate provides and so will not overwrite or delete existing data on the storage device.

Mass storage devices to be registered and in the case of mass storage devices, which are registered, these do not require identifiable delegate details to be stored on the storage device.

Delegates can use any device which can interface with the system (i.e. any USB compliant device, not restricted to USB mass storage) and which has a unique manufacturer, model number and serial number in order to register their wish for a document. This means that through the third party reconciliation service delegates can be re-united online with the documents that they have indicated they wish to collect and their registered details can be passed to exhibitors they have requested to contact them.

A trusted third party (TTP) may include an exhibitor, organizer or a nominated representative. It will be appreciated that the memory stick, can in one embodiment comprise an electronic identity card—an electronic identity stick—and retains only an identity number—which can reconciled with an address or correlated with a person or organization by the trusted third party.

1. A point of display document dispenser comprising: coupling means for accepting coupling of a portable electronic memory device to said point of display dispenser; detection means for automatically detecting when a portable electronic memory device is coupled with said coupling means and providing output indicative thereof; and data transfer means, wherein the data transfer means is operative, on the condition that said detecting means has provided said output, to transfer data, whereby the identity or identifying details of a person inserting the memory device need not be disclosed.

2. A dispenser according to claim 1 wherein the transfer of data comprises transfer of an electronic copy of a document from the display dispenser to the portable electronic memory device.

3. A dispenser according to claim 1 wherein the transfer of data comprises a subsequent transmission of data to the person, by electronic mails or another means.

4. A document dispenser according to claim 2 wherein the electronic copy of the document is an electronic encoding of a brochure, pamphlet or other printed material.

5. A document dispenser according to claim 1 comprising an advertising surface providing indication of the nature of a document which can be dispensed if a portable memory device is coupled to the document dispenser.

6. A document dispenser according to claim 1 further comprising printed material dispensing means for holding one or more printed copies of a document to be dispensed to a user.

7. A document dispenser according to claim 1 adapted for use with a portable electronic memory device comprising flash Memory, Erasable Programmable Read-only Memory, battery maintained Random Access Memory, or magnetic disk drive.

8. A document dispenser according to claim 1 comprising means for initiating download of the document to a portable electronic memory device without further user intervention after said output is detected.

9. A document dispenser according to claim 1 comprising a user operable control button for requesting download of a document to a portable electronic memory device coupled with the dispenser.

10. A document dispenser according to claim 1 comprising two or more user operable control buttons, each control button for selecting a different document in the memory of the document dispenser.

11. A document dispenser according to claim 1 comprising two or more means to accept coupling of a portable electronic memory device.

12. A document dispenser according to claim 11 wherein the two or more means of accepting coupling are enabled to dispense the same document at the same time to two different portable electronic memory devices.

13. A document dispenser according to claim 11 wherein at least one of the means for accepting coupling is adapted to dispense a first document and at least one of the means for accepting coupling is adapted to dispense a second document from the memory.

14. A document dispenser according to claim 1 comprising means for initiating upload of data from a portable memory device into the memory to be dispensed as a document to other portable memory devices when coupled to the point of display document dispenser.

15. A document dispenser according to claim 1, whose memory means currently contains at least one electronic encoding of a document to be dispensed.

16. A document dispenser according to claim 1, wherein the memory means contains a stored control program for operating the dispenser, and the dispenser comprises a data processor capable of running the stored control program.

17. A method of providing an encoded document from a point of display document dispenser comprising the steps of: storing in a memory a copy of a document to be dispensed to a user; accepting coupling of a portable electronic memory device; detecting when a portable electronic device is coupled; and transferring a copy of data representative of said document from said memory to said portable electronic memory device when the presence of the portable electronic memory device is detected.

18. A method according to claim 17 wherein the electronic copy of the document is an electronic encoding of a brochure, pamphlet or other printed material.

19. A method according to claim 17 wherein the copy of the document is transferred from said memory to said portable electronic memory device when the presence of the memory device is detected without further user intervention.

20. A method according to claim 17 wherein two or more documents are stored in the memory, and the document dispensed is controlled according to input from a user operable selector.

21. (canceled)

22. (canceled)

23. (canceled)
